(19) United States
(12) Patent Application Publication
(10) Pub. No.: US 2004/0225672 A1
(43) Pub. Date: Nov. 11, 2004

(54) Method for editing a web site

(76) Inventors: Kevin D. Landers, Sunnyvale, CA (US); Christopher E. McConn, Santa Cruz, CA (US)

Correspondence Address: CANON U.S.A. INC. INTELLECTUAL PROPERTY DEPARTMENT, 15975 ALTON PARKWAY, IRVINE, CA, 92618-3731, US

(21) Appl. No.: 10/429,592

(22) Filed: May 5, 2003

(51) Int. Cl. G06F 7/00

(52) U.S. Cl. 707/102

(57) ABSTRACT

A method, system, and computer program for editing objects displayed in a selected web page. The method, system, and computer program comprising displaying a web page in a window, selecting an object on the web page to edit, retrieving a text string associated with the selected object, displaying the retrieved text string associated with the selected object within an editable field, editing the text string, and storing the text string, wherein the edited text string is automatically displayed on the web page upon storing of the edited text string.

### BACKGROUND OF THE INVENTION

1. Field of the Invention

The present invention relates generally to the field of communication via the Internet or World Wide Web. More particularly, the present invention relates to updating the contents of Internet or World Wide Web screen displays.

2. Description of the Related Art

In today's global economy, Internet or World Wide Web sites hereinafter referred to as “web sites”, provide companies an opportunity to do business with customers on a global level. In order to keep up with their competitors, companies must ensure that their web site contains the most up-to-date information. In order to accomplish this, the pages that make up the web site, hereinafter referred to as “web page”, must be edited and updated to reflect the latest product and company information. In addition, where a company may have multiple, concurrent web sites, the company must ensure that all of the web sites reflect the same up-to-date information. For example, a company desiring to offer the same service on a global level has to ensure that they are communicating with their targeted customers in the customers' native language. To accomplish this, the company typically needs to establish a separate web site for each language spoken by their targeted customers.

The common practice of editing web sites consists of opening the web site's web page code file in a text editor. Any changes or updates are made via the text editor, and then the web page is deployed to the web server via a File Transfer Protocol (FTP) or some other file transfer mechanism. Thus, under this approach, even the most simple or minor modification to a web site requires deploying of the edited web page to the site. This is time-consuming and prone to errors.

To overcome this problem, many web sites have developed a “database driven text” schema. Under this method, variables are created for all of the text associated with the web site, stored them in a database, and then pulled out of the database when they are to be edited. An application is used to perform the editing process, where this application provides the web site editor with an interface to edit all of the text for the web site. After all of the edits have been made, the application is exited and the web site can be browsed.

In the above example of a company typically establishing separate web sites for each language spoken by their targeted customers, implementing the approach of using a text editor to edit a web site can prove to be costly, as well as prone to errors. Employing this method to maintain multiple web sites in multiple languages requires creating a default web site in a default language, copying the full set of default web sites, and then translating the web site into the targeted languages. This approach, while making it easy to translate the web sites from the default language to a targeted language, has several inherent problems. One significant problem is maintenance of the various web sites. When changes to functionality of the web sites are required, these changes must be done for each and every of the web sites. Maintaining each of these web sites is what proves to be costly. The errors arise because the web site developers may not have an understanding of all the targeted languages. Since the ability to read the web site is crucial to making the required changes, a company would need to ensure that each and every web developer understood at least one of the targeted languages or would have to have one web developer to support each of the different language web sites.

Applying the database method to the above example of maintaining multiple web sites in multiple languages is not without its own set of problems and challenges. The translator of the sites in this approach must deal with the fact that content is scattered in the database and that proper translation requires the ability to see the entire web site while translating it. Even though web site development is easier, the task of translating the web site has been made more difficult. Giving the translator the ability to see the context of how the word or phrase being translated is being used will provide for a better, more correct translation.

What is needed is a system that simplifies the method for editing and updating web pages. More particularly, what is needed is an interface for the editor of a web page that permits them to view the entire content of the web page while performing the editing.

### SUMMARY OF THE INVENTION

It is an object of the foregoing invention to address the foregoing difficulty by providing a method for editing a web page while allowing the editor to view the entire contents of the web page during the editing process.

Thus, one aspect of the present invention is a system for editing objects displayed on a selected web page comprising displaying the web page in a window, selecting an object on the web page to be edited, retrieving text string associated with the selected object, displaying the retrieved text string associated with the selected object within an editable field, editing the text string, storing the text string, wherein the edited text string is automatically displayed on the web page upon storing of the edited text string. Preferably, the editable field is displayed in a window different than the window in which the web page is displayed. However, displaying of the editable field is not limited to this approach, and any method for displaying the editable field that allows practice of the present invention is applicable.

In yet another aspect, the contents of a message box displayed on the web page is edited. The method of editing the contents of a message box comprises causing a message box to be displayed on a web page, selecting an option to edit the message box, retrieving text string associated with the message box, displaying the retrieved text string associated with the message box within an editable field, editing the text string, storing the edited text string, and closing the window when editing of the message box is completed

This brief summary has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is a representational view depicting a general configuration of the system in which the process of the present invention is implemented.

FIG. 2 is a block diagram illustrating the internal architecture of a computer implementing the asset management application of the present invention.

FIG. 3 is a flowchart depicting the system of the present invention.

FIG. 4 is a flowchart depicting the preferred steps of the computer-executable code of the server application of the present invention.

FIG. 5 depicts a standard view of a web page.

FIG. 6 depicts the view mode of a web page according to the present invention.

FIG. 7 is flowchart depicting the steps for enabling editing of a web page according to the present invention.

FIG. 8 depicts the edit mode of a web page according to the present invention.

FIG. 9 depicts a user interface for editing the contents of a web page according to the present invention.

FIG. 10 is a flowchart depicting the steps for enabling editing of a web page according to the present invention.

FIG. 11 is a flowchart depicting the steps for editing a web page message box according to the present invention.

FIG. 12 depicts a web page in an example implementing the present invention.

FIG. 13 depicts another web page in an example implementing the present invention.

FIG. 14 depicts yet another web page in an example implementing the present invention.

FIG. 15 depicts a web page message box of the prior art.

FIG. 16 depicts a web page message box according to the present invention.

### DETAILED DESCRIPTION OF THE PREFERRED EMBODIMENTS

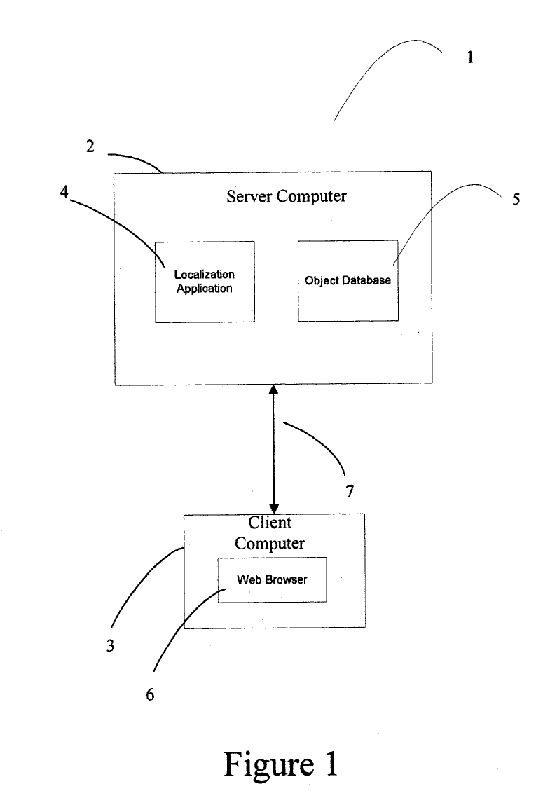

FIG. 1 is a representational view depicting a general configuration of the system in which the system of the present invention is implemented. The present invention is not limited to being implemented via the system depicted in FIG. 1 and any system or platform enabling practice of the invention is applicable. Web page editing system 1 includes server computer 2 and client computer 3, where client computer 3 is connected to server computer 2 via a network interface 7. Server computer 2 contains web page editing application 4 and object database 5. Client computer 3 contains web browser 6.

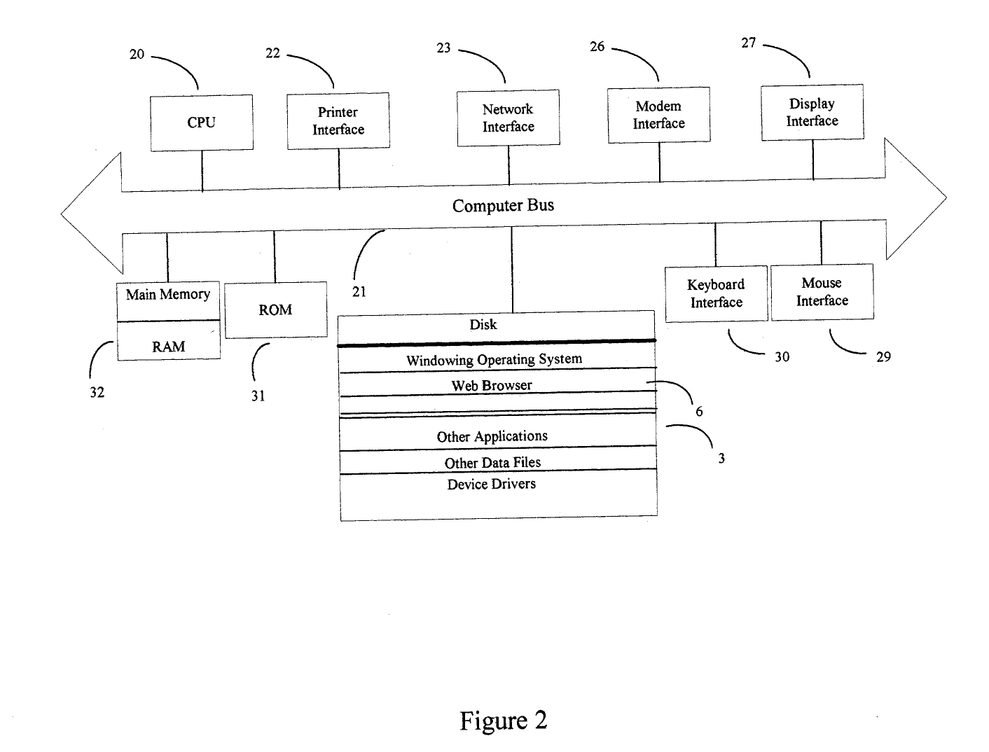

FIG. 2 is a block diagram of the internal architecture of client computer 3. Shown in FIG. 2 is CPU 20, which is preferably a Pentium-type microprocessor, interface to computer bus 21. Also interface to computer bus 21 are printer interface 22, to allow client computer 3 to communicate with a local printer (not shown), network interface 23 to enable communications between client computer 3 and a network, modem interface 26 to enable communications between client computer 3 and its internal modem (not shown), display interface 27 for interfacing with a display monitor (not shown), keyboard interface 30 for interfacing with a keyboard (not shown), and mouse interface 29 for interfacing with a mouse (not shown). Of course, if client computer 3 connects to the World Wide Web 12 by a connection other than a telephone connection, suitable interfaces other than modem interfaces 26 may be utilized.

Read only memory (ROM) 31 stores invariant computer-executable process steps for basic system functions such as basic I/O, start-up, or reception of keystrokes from a keyboard. Main random access memory (RAM) 32 provides CPU 20 with memory storage that can be accessed quickly.

Also shown in FIG. 2 is disk 3, which includes a windowing operating system, web browser 6, which is executable on the particular windowing operating system, other applications which may include word processing, spreadsheet, graphics, and gaming applications. Disk 3 further includes data files and device drivers as shown.

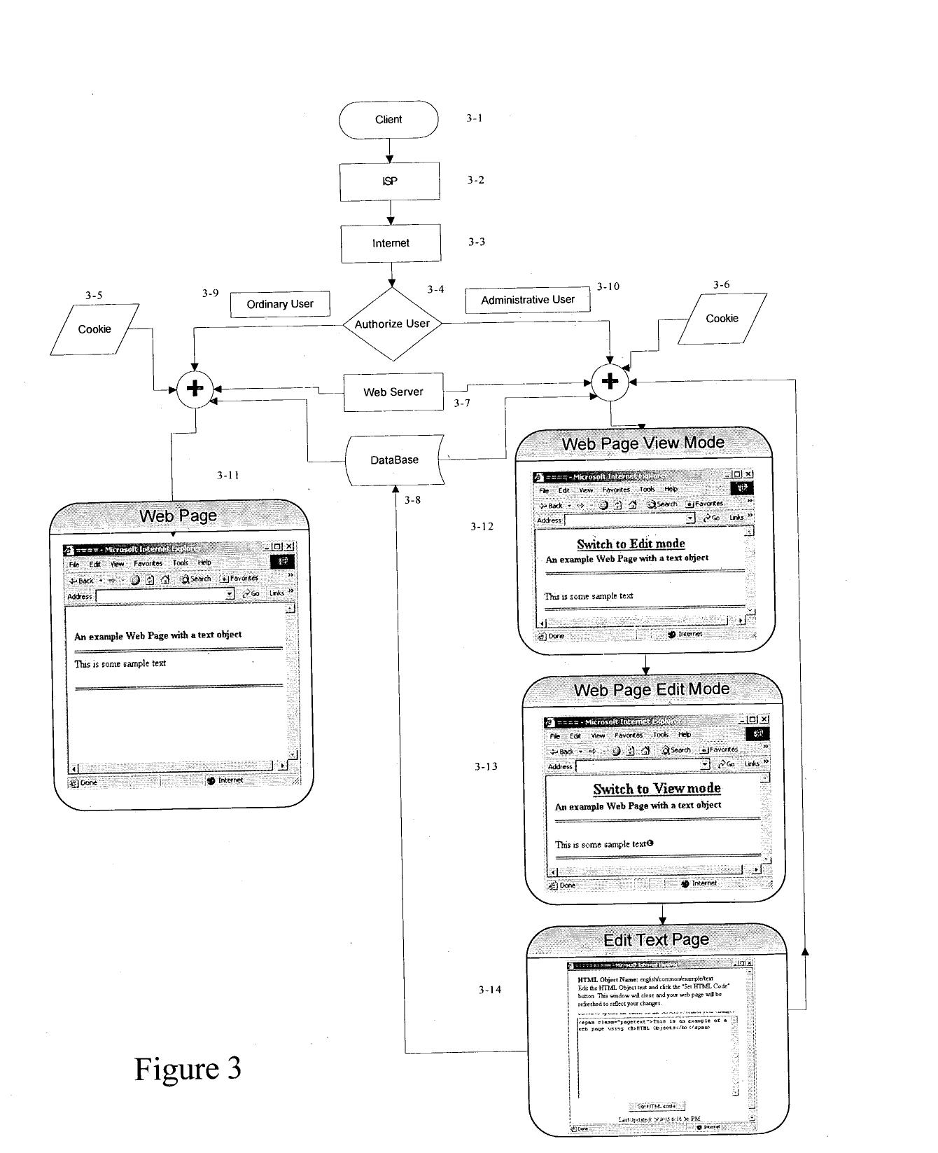

FIG. 3 is a flowchart depicting the system of the present invention. Briefly, client computer 3 connects to the Internet and requests a web page from server computer 2. Based on whether the client is an authorized user or not, server computer 2 allows user to edit objects on the web page.

In more detail, a client (3-1) uses Internet service provider (ISP) 3-2 to connect to web server 3-7 via the Internet 3-3 by requesting a web page from web server 3-7. Any ISP enabling practice of the present invention is applicable.

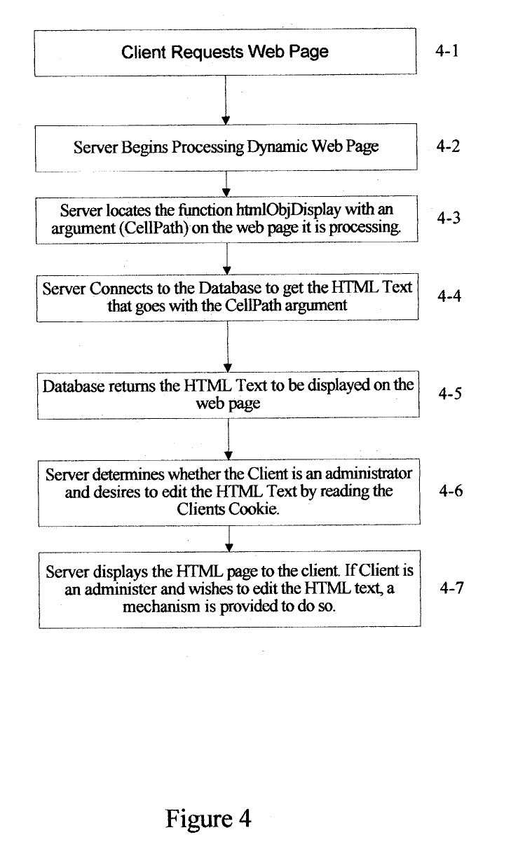

FIG. 4 is a flowchart depicting the preferred steps of the computer-executable code of the present invention residing on web server 3-7 of the present invention. Steps S4-1 through S4-5 reflect standard HTML protocol and are known to those skilled in the art, thus no detailed discussion for them is provided. These steps are included in the preferred embodiment of the present invention so as to fully define the steps of the invention

Upon receipt of a client's request for a web page (S4-1), web server 3-7 begins processing dynamic web pages in step S4-2. In step S4-3, web server 3-7 locates the function “htmlObjDisplay” with an argument (CellPath) on the web page it is processing. Next in step S4-4, web server 3-7 connects to database 3-8 to retrieve the HTML text that is associated with the CellPath argument. Then, in step S4-5, database 3-8 returns the HTML text to be displayed on the requested web page.

Returning to FIG. 3, in 3-4, a determination is made whether the client is an authorized user or not. Performance of this check is described in step S4-6 of FIG. 4. Per step S4-6, web server 3-7 reads the user ID provided by the client computer's 3 cookie 3-5, 3-6, and based on this value, web server 3-7 designates client as either an ordinary user 3-9 or an administrator 3-10. Preferably, computer's cookie 3-5, 3-6 are used to store user authentication information, however, any method of storing a user's authentication information that would enable practice of the present invention is applicable.

In step S4-7, web server 3-7 displays a web page to the client, where the type of web page displayed depends on the determination reached in step S4-6. If web server 3-7 determines in step S4-6 that client is an ordinary user 3-9, then the web page depicted in 3-11 is displayed on client computer 3. If web server 3-7 determined in step S4-6 that client is an administrative user 3-10, then the web page depicted in 3-12 is displayed. The web page depicted in 3-12 changes to the web page depicted in 3-13 if the administrative user decides to edit web page 3-12, where the editing is done via the window depicted in 3-14.

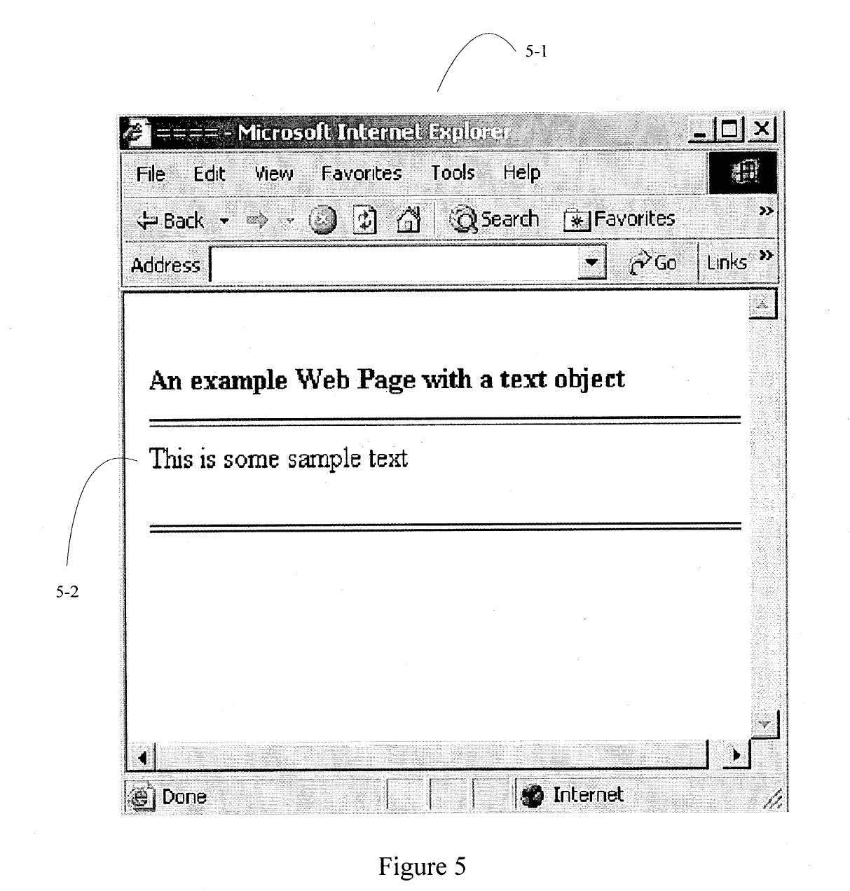

FIG. 5 depicts a larger view of the web page illustrated in 3-11. As shown, the content of web page 5-1 is HTML text 5-2 that was returned by database 8 in step S4-5. No additional characters are displayed on the page.

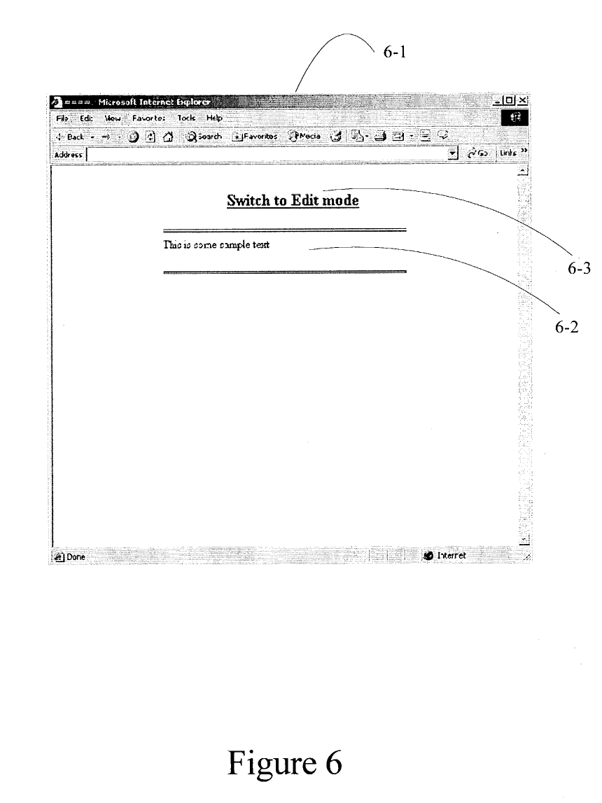

FIG. 6 depicts a larger view of the web page illustrated in 3-12. As shown, the content of web page 6-1 is HTML text 6-2 that was returned by database 8 in step S4-5, along with Switch to Edit Mode 6-3. Switch to Edit Mode 6-3 is the mechanism by which an administrator switches to the edit mode of the present invention as described below.

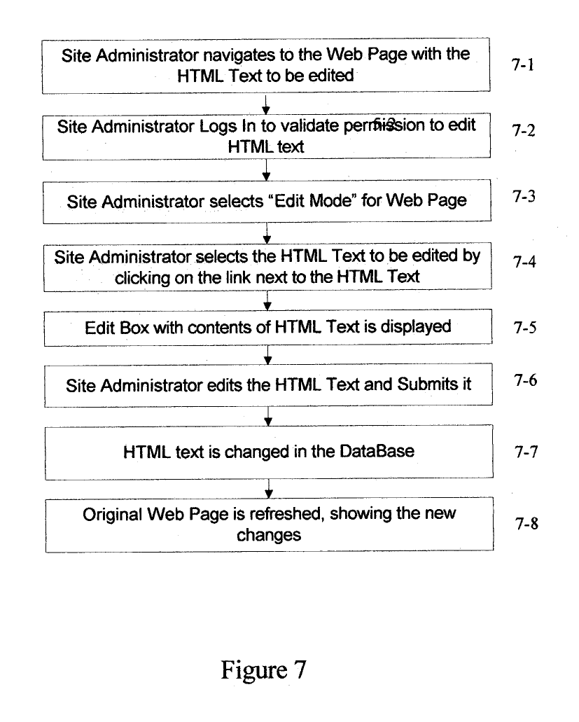

FIG. 7 is a flowchart depicting the steps for enabling editing of a web page according to the present invention. Briefly, FIG. 7 allows an administrator, or any other authorized client, to edit selected HTML objects on a web page while viewing the web page during the editing process.

In more detail, in step 7-1, the administrator navigates to the web page containing the HTML object to be edited as described above with respect to step S4-6 of FIG. 4. Before being provided access to edit the web page, administrator is prompted to enter authentication information in step 7-2. Upon authentication of the administrator by web server 2, web page 6-1 is displayed on client computer 3.

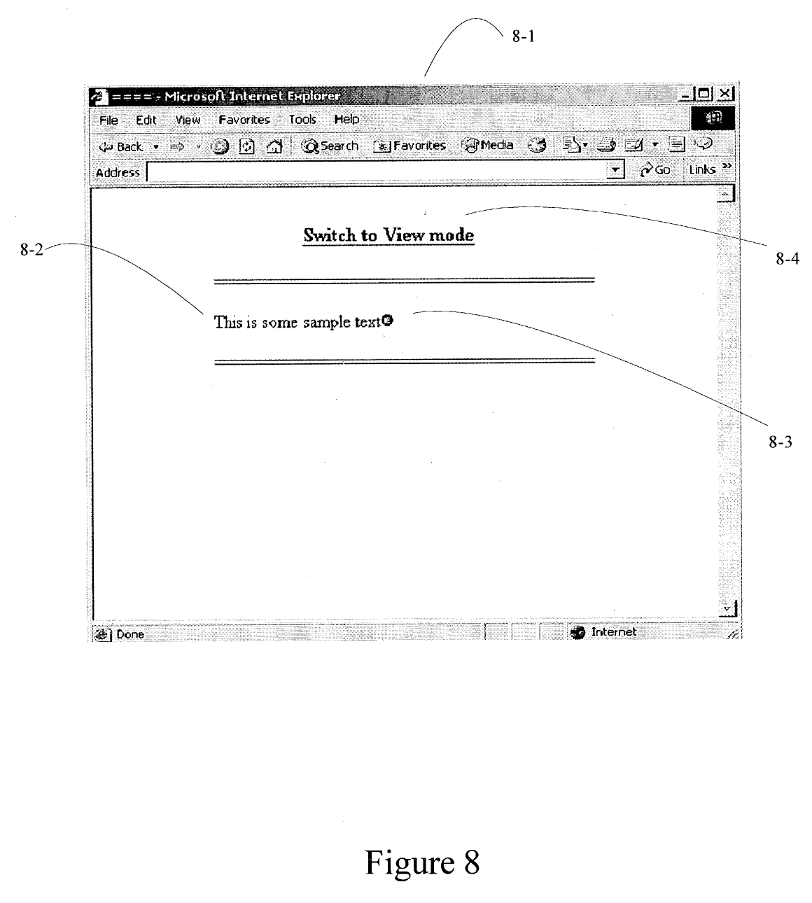

Next, in step 7-3, administrator selects Switch to Edit Mode link 6-3 to initiate the editing function of the present invention. Following selection of Switch to Edit Mode link 6-3, the web page displayed on client computer 3 changes from web page 6-1 of FIG. 6 to web page 8-1 of FIG. 8, where FIG. 8 depicts a larger view of the web page illustrated in 3-13. Web page 8-1 contains, among other things, HTML object 8-2, edit link 8-3, and Switch to View Mode link 8-4, where HTML object 8-2 contains the text returned by database 8 in step S4-5. Switch to View Mode link 84 allows the administrator to toggle back to web page 6-1.

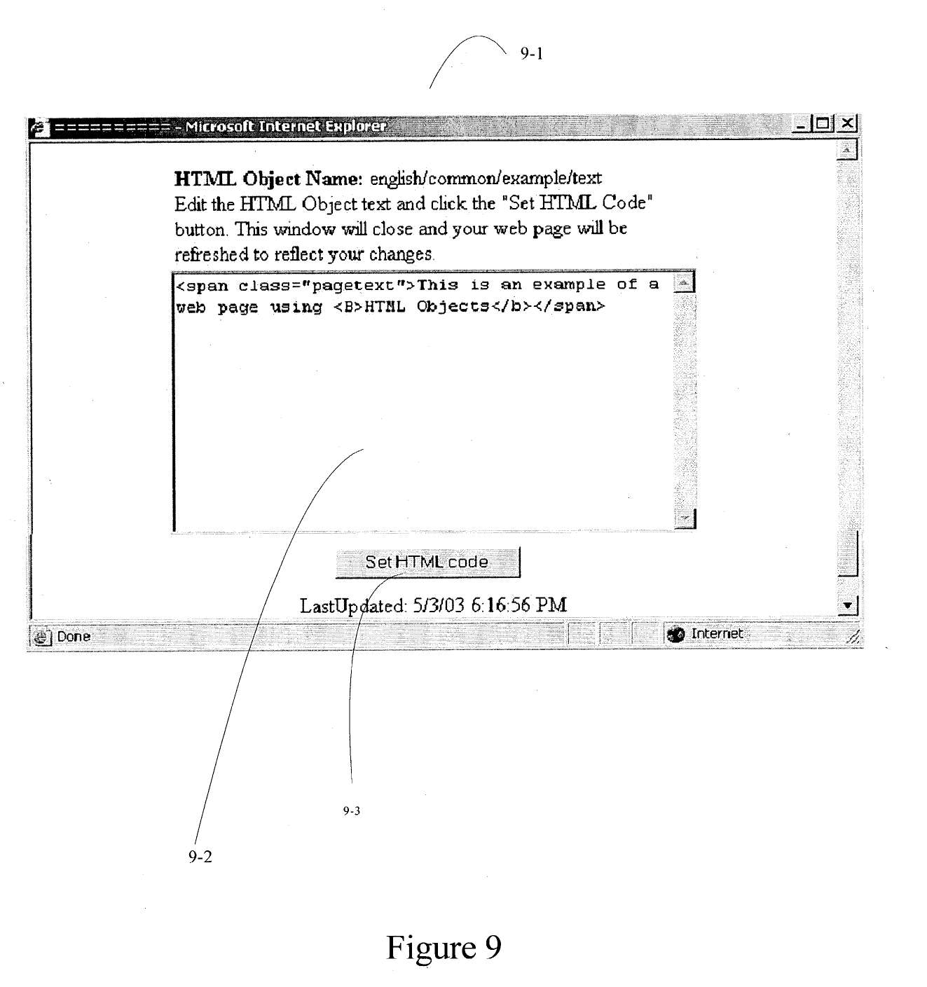

Returning to the flow of FIG. 7, in step 7-4, administrator selects the HTML object to edit by clicking on the link next to the HTML object. In the present case, to edit HTML object 8-2, administrator clicks on edit link 8-3. After edit link 8-3 is selected, in step 7-5, edit window 9-1 of FIG. 9, is displayed and in step 7-6, the administrator edits the contents of HTML object 8-2 via edit window 9-1. Preferably, edit window 9-1 is a different window that the window of web page 8-1. However, displaying of edit window 9-1 is not limited to this approach and any method for displaying edit window 9-1 that allows practice of the present invention is applicable.

FIG. 9 depicts a user interface for editing the contents of an HTML object on a web page according to the present invention. Edit window 9-1 contains edit area 9-2 and Set HTML Code button 9-3. Edit area 9-2 displays the contents of HTML object 8-2 and is where any changes are entered. After any changes are made, they are submitted (step 7-6) by selecting Set HTML Code button 9-3.

Per step 7-7 the text in database 8 associated with edited HTML object 8-2 is updated to reflect the changes. Database 8 is updated when Set HTML Code button 9-3 is selected. Updating of database 8 is performed using standard HTML protocol that is well known to those skilled in the art. In step 7-8, web page 5-1 and 6-1 are refreshed to reflect all of the changes. Refreshing of web page 5-1 and 6-1 preferably occurs automatically upon selection of Set HTML Code button 9-3.

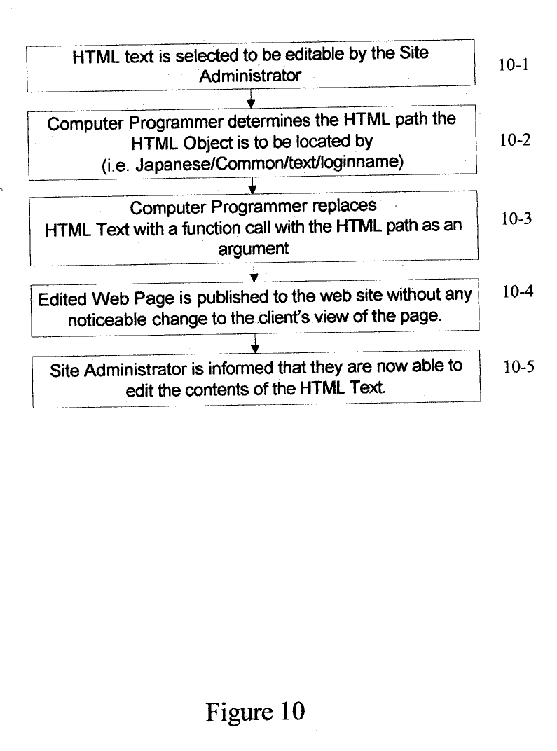

FIG. 10 is a flowchart depicting the steps for enabling editing of a web page according to the present invention. Briefly, a request is made by and administrator for an HTML object to be made editable and the system is modified to accomplish this request.

In more detail, in step 10-1, an HTML object on a web page is selected to be editable by an administrator. In step S10-2, the web page developer determines the HTML path to be used to locate the contents of the HTML object. Then, in step S10-3, the web page developer replaces the HTML object with a function call that uses the HTML path as an argument. The edited web page is then published to its associated web site without any noticeable change to the user's view of the web page (step S10-4). Finally, in step S10-5, the web page developer informs the administrator that the contents of the HTML object can now be edited. Following this notification, to edit the contents of the HTML object, the administrator would follow the steps described above.

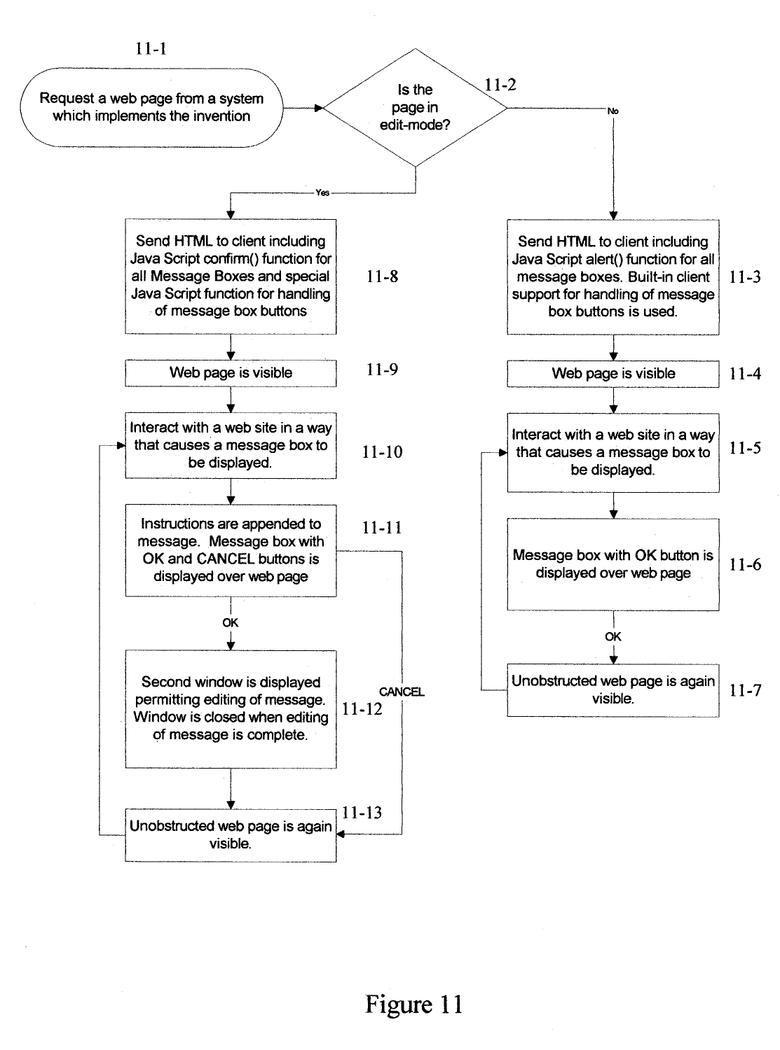

FIG. 11 depicts the flowchart for editing a message box displayed on a web page according to the present invention. Briefly, depending on whether a web page is in view mode or edit mode as described above, the contents of a message box can be edited.

In more detail, in step 11-1, a web page is requested. A determination is made whether the web page is in edit mode or view mode in step 11-2. If the web page is in view mode, flow proceeds to steps 11-3 and 11-4, where standard HTML protocol know to those skilled in the art is used to display the, requested web page. Included in this protocol is a Java Script function used to display “alert” or message windows when interaction with the web page dictates that such a window be displayed. Implementation of this function is well known to those skilled in the art.

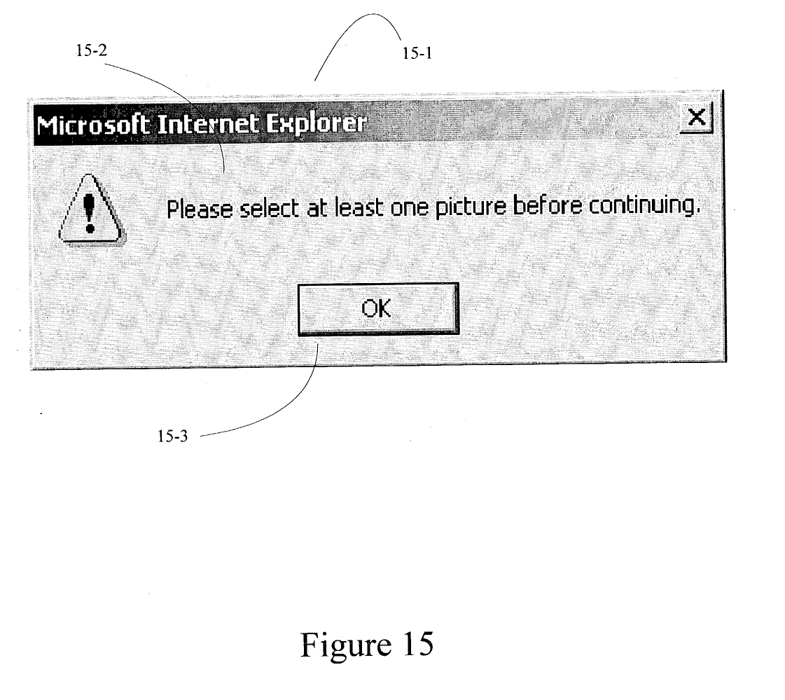

The requestor of the web page interacts with the web page in step 11-5 in such a way that triggers the Java Script function to display a message box. Typically, a message box illustrated in FIG. 15 is displayed. Message box 15-1 contains a message 15-2 along with “OK” button 15-3. The web page requestor, after reading message 15-2, clicks “OK” button 15-3 to close message box 15-1.

If, in step 11-2, it is determined that the web page is in edit mode, flow proceeds to steps 11-8 and 11-9, where standard HTML protocol known to those skilled in the art is used to display the requested web page. Included in this protocol is a Java Script function of the present invention which detects whether the web page is in edit mode or not, and if it is, provides message box 16-1 (described below). The requester of the web page interacts with the web page in step 11-10 in such a way that causes message box 16-1 to be displayed.

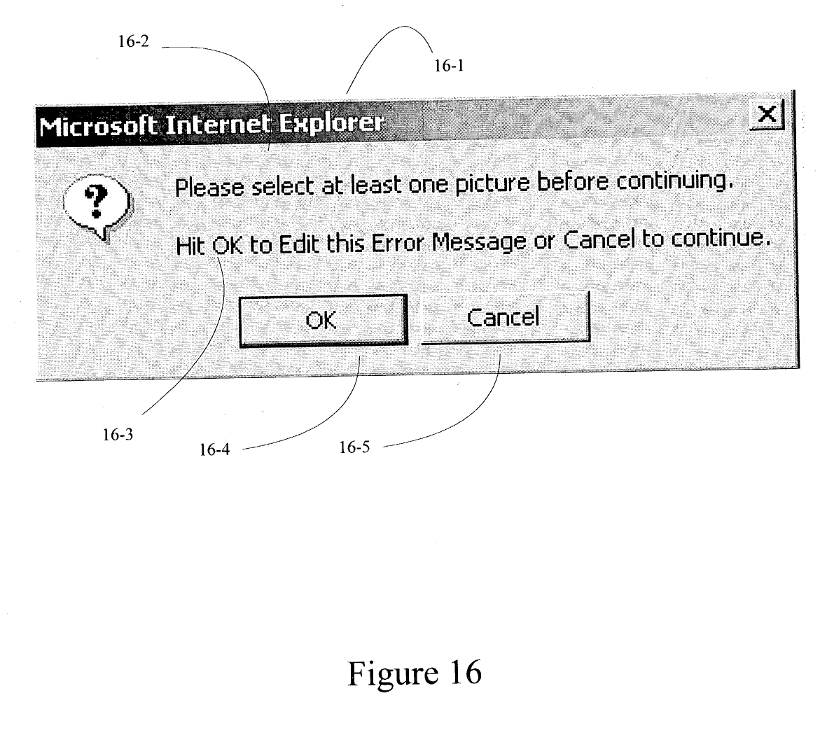

In step 11-11, the message box illustrated in FIG. 16 is displayed. Message box 16-1 contains message 16-2, text indicating how to edit the message 16-3, “OK” button 164, and “CANCEL” button 16-5. Selection of “OK” button 164 allows editing of the message, while selection of “CANCEL” button 16-5 will cancel the editing process and close message box 16-1. If “OK” button 164 is selected, then in step 11-12, message box 16-1 is closed and a window is displayed permitting editing of the message. The window is similar to window 9-1 of FIG. 9. Once editing of the message is completed, the window is closed, and the original web site is displayed in step 11-13. Editing a message box per the above-described approach provides the editor of a message box with the same experience as that of an ordinary user of the web page when the conditions causing the message box to appear are encountered. The ability to experience the same conditions as an ordinary user allows the editor of the message box to provide a more useful message as the editor is able to view the message box within the context of how or why it is being displayed.

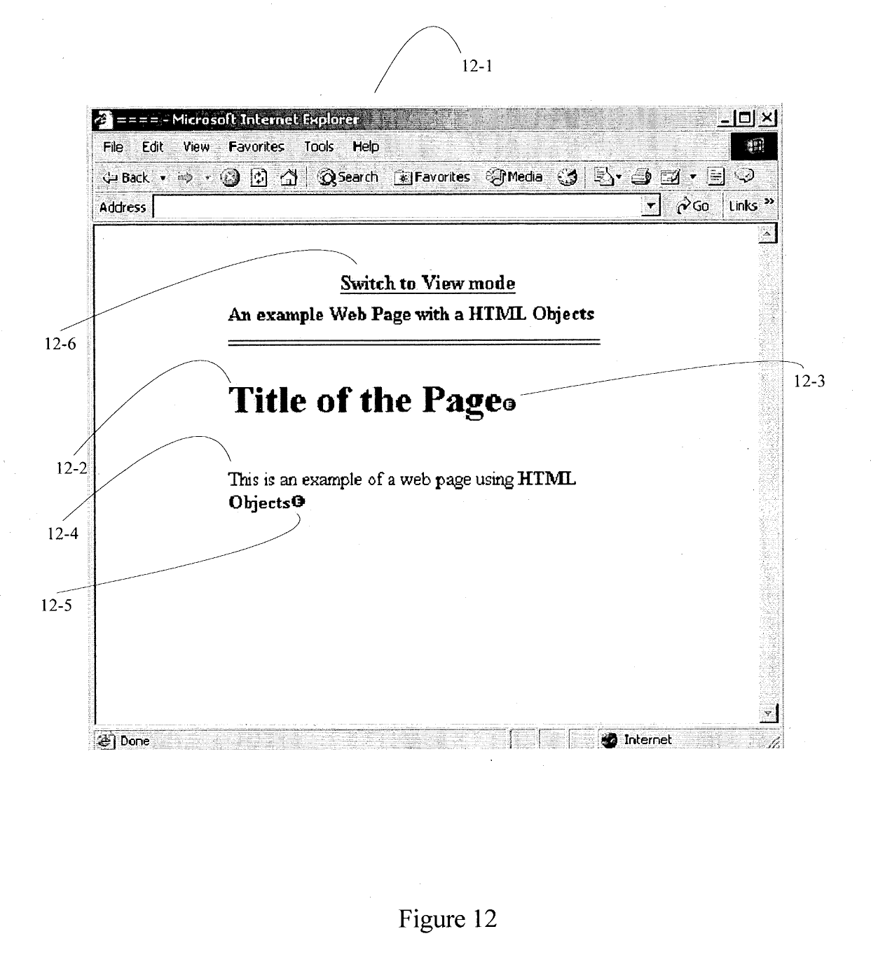

FIGS. 12, 13, and 14 provide one example of the implementation of the above-described invention. In this example, a company maintains the same web site in various languages and must keep all of the web sites in all of the languages consistent with each other. Specifically, the company maintains the same web site in English and in Japanese. All of the original changes or updates are made in English and must be translated for the Japanese web site.

The first step in the process is that the Japanese version web site administrator is notified that a new web page has been added to web site. FIG. 12 depicts the view mode of the web page that would be displayed to the Japanese web site administrator. In order to display web page 12-1, the Japanese version web site administrator would follow the steps of FIG. 7 as described above. Web page 12-1 contains, among other things, HTML object 12-2, HTML object's 12-2 edit link 12-3, HTML object 12-4, HTML object's 124 edit link 12-5, and Switch to View Mode link 12-6. In the present example, HTML object 12-5 is the object on web page 12-1 that requires translation from English to Japanese.

As described above, to edit (translate) HTML object 12-5, the Japanese version web site administrator clicks on edit link 12-5 and edit window 9-1 of FIG. 9 is displayed (not shown in this example). The Japanese version web site administrator would proceed to replace the English text associated with HTML object 12-5 with its Japanese equivalent via edit window 9-1.

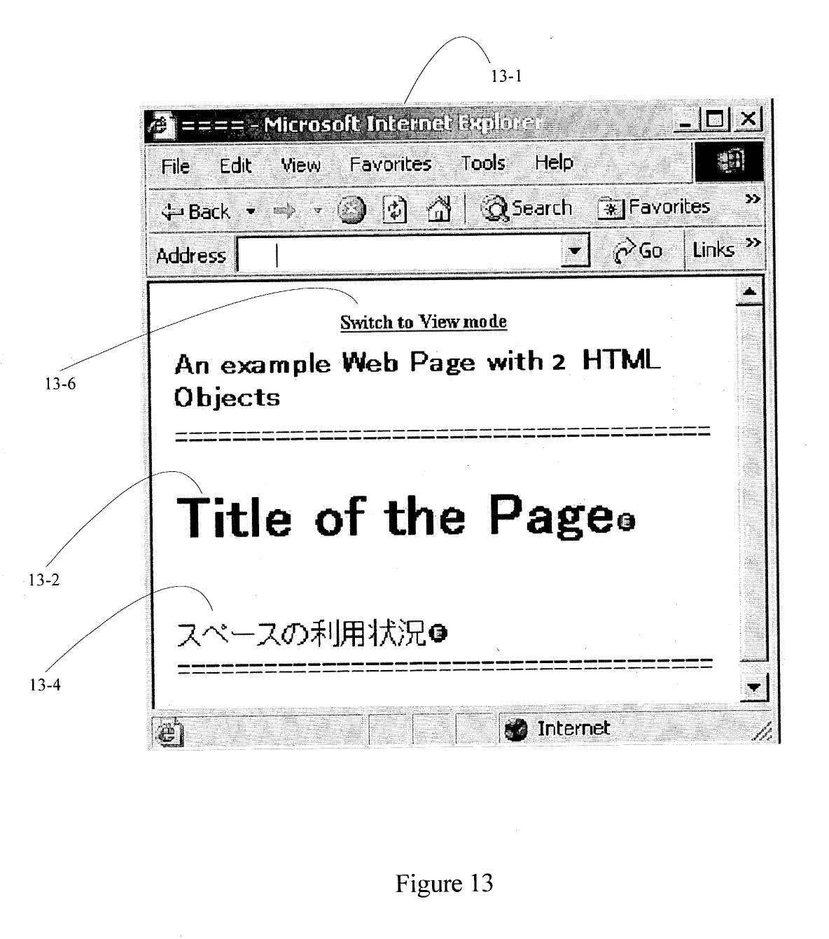

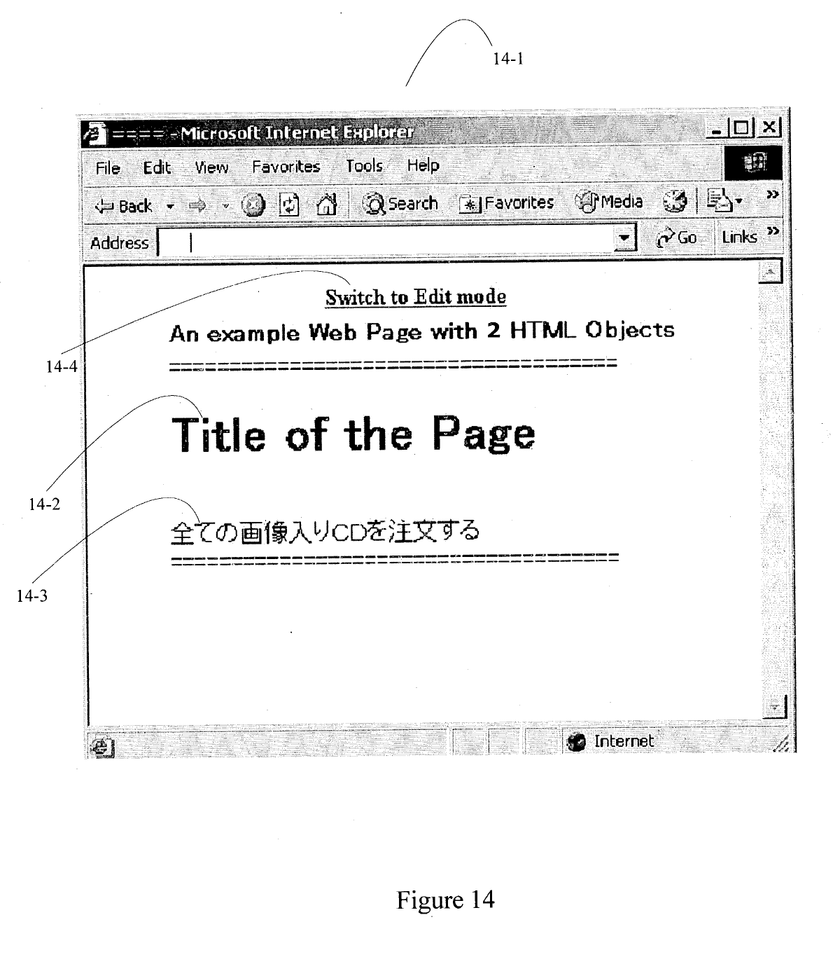

Upon completion of the translation, the newly updated web page with the Japanese translation would be displayed. FIG. 13 depicts the newly updated web page. Specifically, HTML object 13-4 now appears as Japanese text, while HTML object 13-2, which was not edited, remains as English text. When the Japanese version web site administrator has completed the translation procedure, Switch to View Mode link 134 is selected to return back to the view mode display, which is depicted in FIG. 14. Web page 14-1 contains, among other things, the unedited HTML object 14-2, translated HTML object 14-3, and Switch to Edit Mode link 14-4.

While the invention is described above with respect to what is currently its preferred embodiment, it is to be understood that the invention is not limited to that described above. To the contrary, the invention is intended to cover various modifications and equivalent arrangements within the spirit and scope of the appended claims.

What is claimed is:

1. A method for editing objects displayed in a selected web page comprising the steps of:
displaying a web page in a window;
selecting an object on the web page to edit;
retrieving text string associated with the selected object;
displaying the retrieved text string associated with the selected object within an editable field;
editing the text string; and
storing the edited text string,
wherein the edited text string is automatically displayed on the web page upon storing of the edited text string.

2. A method according to claim 1, wherein the text string contains ASCII text.

3. A method according to claim 1, wherein the text string contains HyperText Markup Language code.

4. A method according to claim 1, wherein authentication of a user is required prior to selecting an object on the web page to edit.

5. A method according to claim 1, wherein the editable field is displayed in a window different than the window in which the web page is displayed.

6. A method according to claim 1, wherein the editable field is displayed in the same window as the web page.

7. A method according to claim 1, further comprising editing a message box displayed on the web page.

8. A method according to claim 7, comprising the steps of
causing a message box to be displayed on the web page;
selecting an option to edit the message box;
retrieving text string associated with message box;
displaying the retrieved text string associated with the message box within an editable field;
editing the text string;
storing the edited text string; and
closing the window when editing of the message is completed.

9. A system for editing objects displayed in a selected web page comprising:
computer-readable executable code means for displaying a web page in a window;
computer-readable executable code means for selecting an object on the web page to edit;
computer-readable executable code means for retrieving text string associated with the selected object;
computer-readable executable code means for displaying the retrieved text string associated with the selected object within an editable field;
computer-readable executable code means for enabling editing of the text string; and
computer-readable executable code means for storing the edited text string,
wherein the edited text string is automatically displayed on the web page upon storing of the edited text string.

10. A system according to claim 9, wherein the text string contains ASCII text.

11. A system according to claim 9, wherein the text string contains HyperText Markup Language code.

12. A system according to claim 9, wherein authentication of a user is required prior to selecting an object on the web page to edit.

13. A system according to claim 9, wherein the editable field is displayed in a window different than the window in which the web page is displayed.

14. A system according to claim 9, wherein the editable field is displayed in the same window as the web page.

15. A system according to claim 9, further comprising computer-executable code means for enabling editing a message box displayed on the web page.

16. A system according to claim 15, comprising:
computer-executable code means for causing a message box to be displayed on the web page;
computer-executable code means for selecting an option to edit the message box;
computer-executable code means for retrieving text string associated with message box;
computer-executable code means for displaying the retrieved text string associated with the message box within an editable field;
computer-executable code means for enabling of editing the text string;
computer-executable code means for storing the edited text string; and
computer-executable code means for closing the window when editing of the message is completed.

17. A computer-readable memory medium storing computer-executable process steps for editing objects displayed in a selected web page comprising:
a displaying step for displaying a web page;
a selecting step for selecting an object on the web page to edit;
a retrieving step for retrieving text string associated with the selected object;
a displaying step for displaying the retrieved text string associated with the selected object within an editable field;
an enabling step for enabling editing of the text string; and
a storing step for storing the edited text string,
wherein the edited text string is automatically displayed on the web page upon storing of the edited text string.

18. A computer-readable memory medium storing computer-executable process steps according to claim 17, wherein the text string contains ASCII text.

19. A computer-readable memory medium storing computer-executable process steps according to claim 17, wherein the text string contains HyperText Markup Language code.

20. A computer-readable memory medium storing computer-executable process steps according to claim 17, wherein authentication of a user is required prior to selecting an object on the web page to edit.

21. A computer-readable memory medium storing computer-executable process steps according to claim 17, wherein the editable field is displayed in a window different than the window in which the web page is displayed.

22. A computer-readable memory medium storing computer-executable process steps according to claim 17, wherein the editable field is displayed in the same window as the web page.

23. A computer-readable memory medium storing computer-executable process steps according to claim 17, further comprising computer-executable process steps editing a message box displayed on the web page.

24. A computer-readable memory medium storing computer-executable process steps according to claim 23, comprising:
a causing step for causing a message box to be displayed on the web page;
a selecting step for selecting an option to edit the message box;
a retrieving step for retrieving text string associated with message box;
a displaying step for displaying the retrieved text string associated with the message box within an editable field;
an editing step for editing the text string;
a storing step for storing the edited text string; and
a closing step for closing the window when editing of the message is completed.
